(19) United States
(12) Patent Application Publication
(10) Pub. No.: US 2013/0325542 A1
(43) Pub. Date: Dec. 5, 2013

(54) SYSTEM AND METHOD FOR DISTRIBUTION OF UTILITY ASSET DATA IN A PROJECT AREA

(71) Applicant: GLOBAL PRECISION SOLUTIONS, LLP., Grand Junction, CO (US)

(72) Inventors: Page Tucker, Grand Junction, CO (US); Peter James Lynch Forster, Delta (CA)

(73) Assignee: GLOBAL PRECISION SOLUTIONS, LLP., Grand Junction, CO (US)

(21) Appl. No.: 13/758,678

(22) Filed: Feb. 4, 2013

Related U.S. Application Data
(60) Provisional application No. 61/654,720, filed on Jun. 1, 2012.

(51) Int. Cl. G06Q 10/06

(52) U.S. Cl. CPC G06Q 10/06313
USPC 705/7.23

(57) ABSTRACT

A system and method for distribution of utility asset data including: receiving by a computer a selected project area; searching a database including location data and responsible utility companies for a plurality of utility assets to identify utility assets in the selected project area; determining an associated utility company for each of the identified utility assets in the selected project area; and transmitting a notification to the determined utility companies.

### CROSS-REFERENCE TO RELATED APPLICATIONS

This Patent Application claims the benefits of U.S. Provisional Patent Application Ser. No. 61/654,720, filed on Jun. 1, 2012 and entitled “System And Method For Distribution Of Utility Asset Data In A Project Area,” the entire content of which is hereby expressly incorporated by reference.

### FIELD OF THE INVENTION

The present invention relates generally to data distribution; and more particularly to a system and method for distribution of utility asset data in a project area.

### BACKGROUND

There are many utility assets above ground and below ground in a geographic (project) area that need to be protected and avoided during construction activities in the project area. Furthermore, often some of such utility assets are damaged or need to be repaired and/or updated. Included in these assets are utility lines and components and protected areas, such as archeological sites, riparian zones, and habitat of endangered species. These utility lines include, without limitation, electric power lines, telephone lines, water lines, sewer lines, fiber-optic cable lines, natural gas transmission lines, natural gas distribution lines, and utility lines for transporting hazardous liquids.

There are several practices currently in use to help address damage prevention when groundbreaking or other construction equipment is used around utilities and other assets that need protection. One example includes marking the location of an underground utility asset by painting lines on the ground. Commonly, the utility companies and/or locate service companies are called to the site to place marks (place flags or spray paint on the surface of the ground with an identifying color, for example, red for electric lines, yellow for gas lines and so forth) on the surface to demarcate the location of a specific utility line and/or its components. Such marking is temporary by nature and typically lasts only for the one earth moving operation or ground breaking operation such as removing the surface cover such as pavement, cement, dirt, for which the utilities were marked.

Another typical approach is to make a record of the location of the utility lines as the line was placed in the earth by creating a drawing showing the asset location relative to an existing feature or landmark such as a curb or building. However, the accuracy of the location is dictated by the accuracy of the reference point.

Currently, there are ONECALL™ centers that act as a central clearinghouse for marking of utilities in areas where construction (e.g., digging) will occur. A user must call ONECALL™ and tell them that the user will be digging, for example, at the corner of 7^{th} street and ELM Ave (a project area). ONECALL™ then sends a locate ticket (notification) to all utility companies that may have utilities in the designated project area. The utility companies are then required to mark the location of the utilities. Typically, the utility companies with utilities in the project area then send a representative to locate the utility and physically mark the area that has buried utility assets, above the ground. In this way, a ONECALL™ entity would serve as the sponsor or clearing house for a public damage prevention system by manually and temporarily marking the ground.

However, the ONECALL™ entity may not have accurate and up-to-date data, not only as to the precise locations of the utility assets in the project area, but also, as to the current utility companies responsible for certain utility assets in the area. Furthermore, this process that includes a middleman (sponsor or clearing house) is costly and time consuming and results in errors.

### SUMMARY

In some embodiments, the present invention is a computer implemented method for distribution of utility asset data. The method includes: receiving by a computer a selected project area; searching a database including location data and responsible utility companies for a plurality of utility assets to identify utility assets in the selected project area; determining an associated or responsible utility company for each of the identified utility assets in the selected project area; and transmitting a notification to the determined utility companies.

In some embodiments, the present invention is a system for distribution of utility asset data. The system includes an input device for receiving a selected project area; a database for storing location data and responsible utility companies for a plurality of utility assets to identify utility assets in the selected project area; a processor for determining an associated or responsible utility company for each of the utility assets in the selected project area; and a transmitter for transmitting a notification to the determined utility companies.

In some embodiments, the selected project area may be determined by receiving user selection identifying an area on a map, specifying an address, specifying an intersection, specifying a land mark, or specifying a postal zip code.

In some embodiments, the utility assets in the selected project area are identified from the database based on the location data, project type, project scope and/or utility asset type.

In some embodiments, the database further includes contact information and type of notification to be sent for each of the responsible utility companies, a protocol record including one or more of a safety measure to be put forth to protect a respective utility asset from being damaged, certification process, repair process, replacement process, and regulations governing the type of the respective utility asset or the responsible utility company for the respective utility asset.

### BRIEF DESCRIPTION OF THE DRAWINGS

FIG. 1 is an exemplary block diagram of major components of a system constructed, according to some embodiments of the present invention.

FIG. 2 is an exemplary overview of a data management system 200, according to some embodiments of the present invention.

FIG. 3 shows an exemplary data record 300 for each utility asset in a precision database, according to some embodiments of the present invention.

FIG. 4 shows an exemplary GIS data transaction record for each utility asset in a precision database, according to some embodiments of the present invention.

FIG. 5 shows an exemplary process flow executed by one or more computers, according to some embodiments of the present invention.

### DETAILED DESCRIPTION

The present invention is a system and method for identifying a project (e.g., a construction) area, and automatically notifying the utility companies responsible for or associated with the utility assets in the project area of the planned construction and details about the construction.

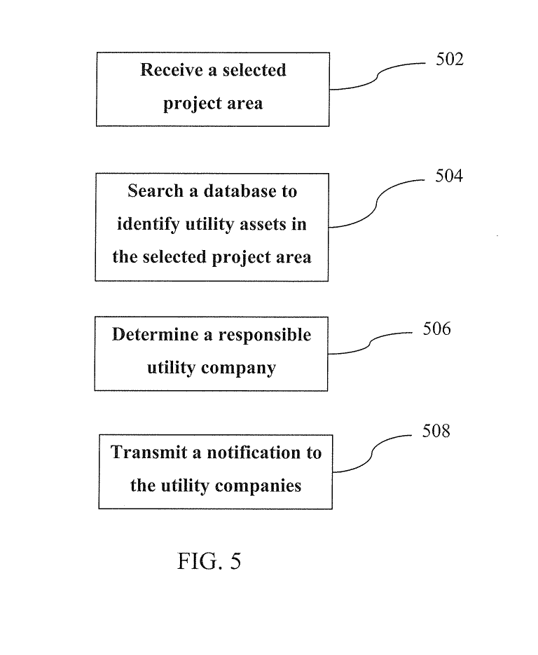

FIG. 5 shows an exemplary process flow executed by one or more computers, according to some embodiments of the present invention. As shown, in block 502, a selected project area, or an area of interest (identified by a user) is received. For example, a user can select or identify a project area or an area of interest by circling an area (however small or large the area may be) on a map, identifying the street address of the project area, identifying an intersection, a land mark, specifying a postal zip code or the like. The selected/identified area is then received (for example, by a server computer), according to the present invention.

In block 504, the invention then searches a database of the utility assets and identifies all the utility assets in the project area. In block 506, the relevant responsible utility company for each identified utility asset is determined from the data stored in the database. The invention then sends (transmits) an electronic notification that may include details of the project area (buffer zones, who to contact, what processes, etc.) and the construction to (a responsible person or department in) the utility companies, as shown in block 508. For example, buffer zones are based on the confidence that the utility assets owner (or one that is responsible for it) has in their location data of the utility asset and the type of the utility asset.

The utility asset owners (companies) then conduct proper protocol and safety measures to protect the utilities within the project area from being damaged during construction. The utility owners of concern may be a single utility owner or multiple utility owners. The utility assets may have different buffer zone sizes and different protocols which contribute to activation of the notification. Similarly, the utility companies may have different protocols. Utilizing the present invention makes it unnecessary to physically mark the surface to indicate a buried utility asset since the information is electronic and more precise than a marking or flag. For example, the precise location data of the utility assets in the project area, can be downloaded into portable devices and/or digging equipment, which would warn the users and operators as they or the equipment approaches the buried utility assets, taking into account the buffer zones associated with some of the buried utility assets.

In some embodiments, the notification may also be sent simultaneously or at a later time to field personal of various entities on a job (project) site as well as government, and municipal and regulatory agencies, depending on the project type and/or the project scope. For example, if the project type is a large construction project that needs one or more streets to be cordoned off, the Police Department and/or the local traffic agencies may be notified. As another example, if the project scope includes digging around existing gas lines/pipes, the Fire Department may also be notified so that they will be on alert, when that part of the project is on-going.

The above system and processes according to the present invention may be utilized just before a project (e.g., a construction) starts, during the course of the project (construction), and/or in the design and planning stages of the project (construction). For example, the invention may be utilized by an architect that is drawing the plans for a building and planning the construction according to restrictions such as regulations or cost estimates. Once the drawing indicates an approximate (or accurate) project area, the impact of different parts or areas of the project (e.g., how deep different portions of the building have to be, or where the sewage lines, or gas lines are to be planned), a notification is sent to appropriate responsible or associated entities, so that any changes required by these appropriate responsible entities can be incorporated into the plan or design, before the construction is started.

As another example, during the course of the project, an unforeseen buried utility asset may be discovered by a field worker. The worker can then circle the area in which the unforeseen utility asset is discovered or input the (e.g., GPS) location data of the unforeseen utility asset into his/her mobile device. The invention then identifies all the utility assets adjacent (predetermined or set by the user) to the unforeseen utility asset. A notification is then automatically generated and sent to the responsible/appropriate entities associated with the adjacent utility assets.

In some embodiments, the invention stores data about the utility assets, for example, in a precision integration (PI) grid that includes (above or below ground) utility location data combined with a GIS Landbase that includes satellite and/or other imagery and mapping information. Here, precision GPS refers to a GPS system that may provide position information with accuracies within centimeter ranges. The stored utility location information may be recalled anywhere, anytime using a computer network, such as the Internet and an electronic device such as a portable smart phone or similar devices.

That is, One Call centers currently aggregate data and use many manual and antiquated processes to determine dig zones and assets of concern that could be impacted by construction activity. In contrast, the method and system of the present invention electronically aggregates as well as “conflates” the data into a single source view and quantifies, measures and qualifies the data as well as the data layers in order to provide data and confidence levels associated with the data, which in turn indicate what type of business decision can be made and the risk that could be associated to that decision. If the risk level and confidence is of concern, the appropriate data source or data layer that needs to be verified and rectified can easily be identified based on precision and pedigree levels in order to increase user confidence and lower risk levels. For example, for high risk utility assets such as gas lines, the required accuracy or precision of the data may be higher. Conversely, for lower risk utility assets such as sewage lines, the desired accuracy or precision may not be as high.

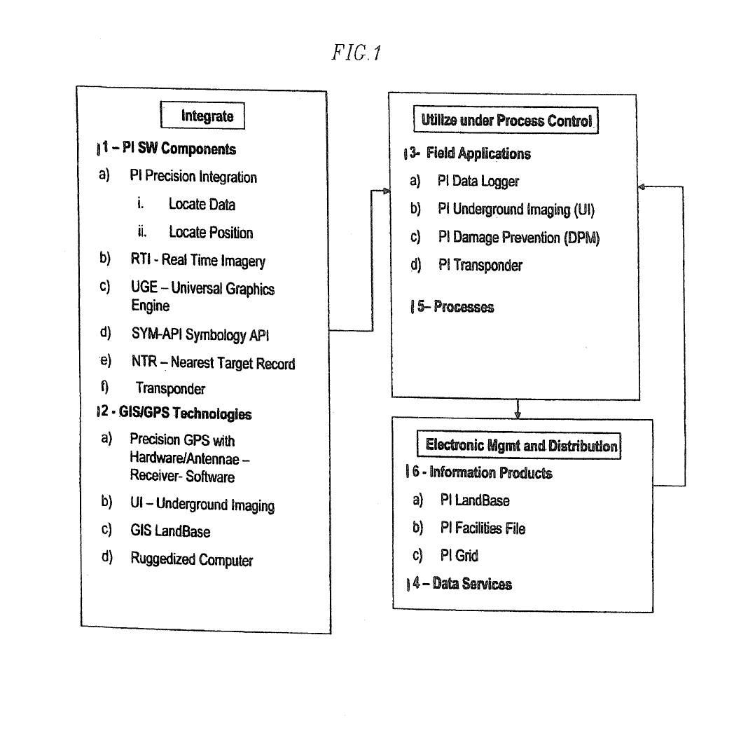

FIG. 1 is an exemplary block diagram of major components of a system constructed, according to some embodiments of the present invention. As shown, the major components include PI SW Components 11, GIS/GPS and other location technologies, field software applications 13, data services including electronic data management and distribution system 14, a plurality of different processes 15, and information products 16.

The PI SW Components and the GIS/GPS technologies are integrated to develop or provide the field software applications that are utilized under a process control by the Processes 15. The system, of the present invention, utilizing field software applications (executed by a mobile device) under process control, generates or produces the information products 16 that are utilized at different life cycle steps by a user to provide, in various forms, and optionally, on a subscription basis information products. The information products include notification to the utility companies with utilities in the project area of the planned construction, which are managed and distributed by an electronic management and distribution system.

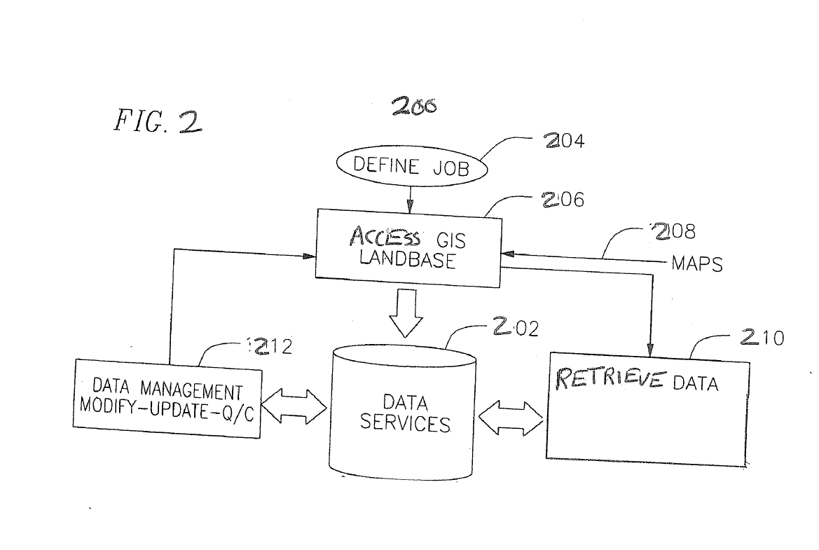

FIG. 2 is an exemplary overview of a data management system 200, according to some embodiments of the present invention. The illustrated operations may be performed by one or more computers in conjunction with various data services and a precision database 202, as explained herein. Initially, a project (job) is defined in block 204. This includes identifying the location and area of the project, the type of project, the scope of the project, contractors and construction companies for the project, project schedules, etc. For example, if a sign is being placed in an area and the sign installation is to bury the sign pole 2 ft deep into a 1 ft. wide hole that has been created using an earth auger and place cement into the hole, then utility lines in the area of the project parameters, in this case within 2 ft of the ground surface plus an added buffer zone, should be identified and the associated entities notified. For example, if the sign pole installation is over a sewer line and the sewer line is 9 ft and no other lines are in the area of concern, the pole installation may able to proceed since it will not have any effect on the sewer line, which is buried 9 ft deep, however, if records on file indicate that a gas line is somewhere in proximity and the confidence level of the precise location data is low, then perhaps additional measures should be taken before breaking ground even for just a pole installation. Once the pole is installed the system could update the pole installation with GPS data, Images, such as photographs and field notes.

Identifying the location and area of the project may be accomplished in various ways including latitude and longitude or GPS. For example, a user can identify a project area by circling the project area on a map (e.g., a Google™ Earth, Microsoft Virtual Earth, etc.) using a pointing device, such as a mouse, electronic stylus or touch screen, identifying the street address of the construction area, identifying an intersection, a land mark, a postal zip code, or the like

Referring back to FIG. 2, a GIS Landbase 206 is then accessed by the one or more computers. The GIS Landbase is created utilizing map data 208 and is stored in a database. The precision database 202 stores information about the utility assets, including their locations, types, and owners. Using the precision database 202, which includes the utility assets and their locations, the utility assets relevant to the project area (and optionally to the project type and/or scope) are then identified. Data related to the identified utility assets is then retrieved from the precision database. The retrieved data includes the utility type, location, the utility company responsible for, associated with, or owing each utility asset, the contact information of such utility companies. Data management operations 212 are then invoked to manage and distribute data, for example, to automatically send a notification to the respective utility asset owners of the planned construction and its details, for example by a transmitter, which may be part of the one or more computers.

In some embodiments, the notification may also be sent to the personnel in the field and other related parties, as explained above. The notification may be in the form of an email, a facsimile, text message, an automatic phone call, an upload of data into a certain website, database, electronic device or the like.

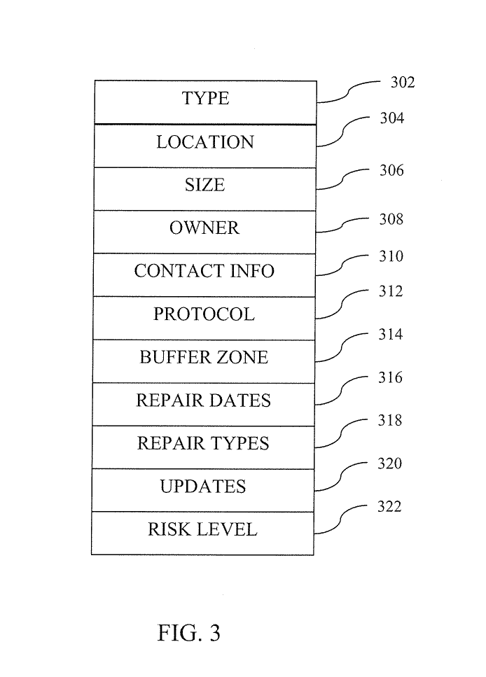

FIG. 3 shows an exemplary data record 300 for each utility asset in a precision database, according to some embodiments of the present invention. As shown, the data record 300 include a record 302 for utility type. The utility type record 302 may include the type of the utility such as, gas pipe, water pipe, sewage pipe/line, telephone line, electricity line, television cable line, etc. Additionally, the type or material of the pipes and lines may be included as well as any other media including sketches, design drawings, photos, audio, video, etc. For example, a water pipe may be a cupper water pipe or a steel water pipe. Likewise, a telephone line may be a twisted pair copper line, a fiber optic line, or the like. Similarly, a sewage pipe/line may be a metal pipe, a cement pipe, etc. The utility type record 302 may also include connectivity information, for example, what cables and pipes connect to the various topside (on the ground) utility structures when it was installed, last inspected, etc.

A location record 304 includes the location, for example, latitude and longitude, GPS coordinate, etc. of the utility asset. The location record may also include a relative distance to a landmark on the ground and/or altitude (depth) information. A size record 306 includes the size, for example, diameter or width of the utility asset. The size record 306 may also include the orientation of the utility asset.

An utility owner record 308 includes the owner of the utility asset, or the company which is responsible for maintaining the utility asset. A contact information record 310 may include the name of a person, and/or a department within the company, which owns or is responsible for or associated with the utility asset, a phone number, a fax number and/or an email address, and the type of the notification and the manner of sending the notification. For example, information such as Edison Company, Construction Department, Joe Black, (123) 456-7890, Joe_black@construction.com may be included in the contact information record 310.

A protocol record 312 may also be included with the data record 300 for each utility asset. The protocol record 312 includes the type, format and/or nature of the notification. The protocol record 312 also includes protocols (such as safety measure to be put forth to protect that utility assets from being damaged during construction, certification process, repair process, replacement process, etc.) for the utility type and/or utility owner. For example, the following protocol or safety measure/warning may be included with a telephone line:

“Sketches, design drawings, as-builts, and plans provided by Telephone Co. are circuit diagrams only and indicate the presence of telecommunications assets in the general vicinity of the geographical area shown. Exact topside attributes and measurements cannot be given with any certainty as these items may change over time. Buried telecommunications assets seldom follow straight lines and careful on-site investigation is essential to determine their exact location.

The Telephone Co. will offer free “Cable Awareness & Advanced Map Reading Presentations” when requested.”

An optional buffer zone record 314 includes a buffer zone around the perimeter of the utility asset, depending of the type and size of the utility, regulations governing the type, and/or the utility owner, as well as confidence in the data provided. The buffer zone extends the size (perimeter) of the utility asset for damage prevention, depending of the type or risk level of the utility asset. Optionally a repair dates record 316 and a repair type record 318 may be included with the data record 300 to indicate a log/history of the repairs, movement or replacements of the utility asset. An optional update record 320 include the date and nature of the data updates for the utility asset and may include the names of the persons or organizations that performed the updates, the date that the updates were completed, and the reasons for the updates.

An optional risk level record 322 may be included with all or some of the utility assets, which includes the risk level of the utility asset depending on the type of the utility asset, the location of the utility asset, and/or the location of a utility asset within a utility grid, as well as the precision and pedigree of the data source. For example, a gas pipe may have a higher risk level than a sewage pipe or a water pipe. Similarly, a high-voltage electricity line may have a higher risk than a low-voltage electricity line or a television cable line. Likewise, a portion of an electricity line at the “heart” of a power grid may have a higher risk level than another portion of the same electricity line at the end of the power grid.

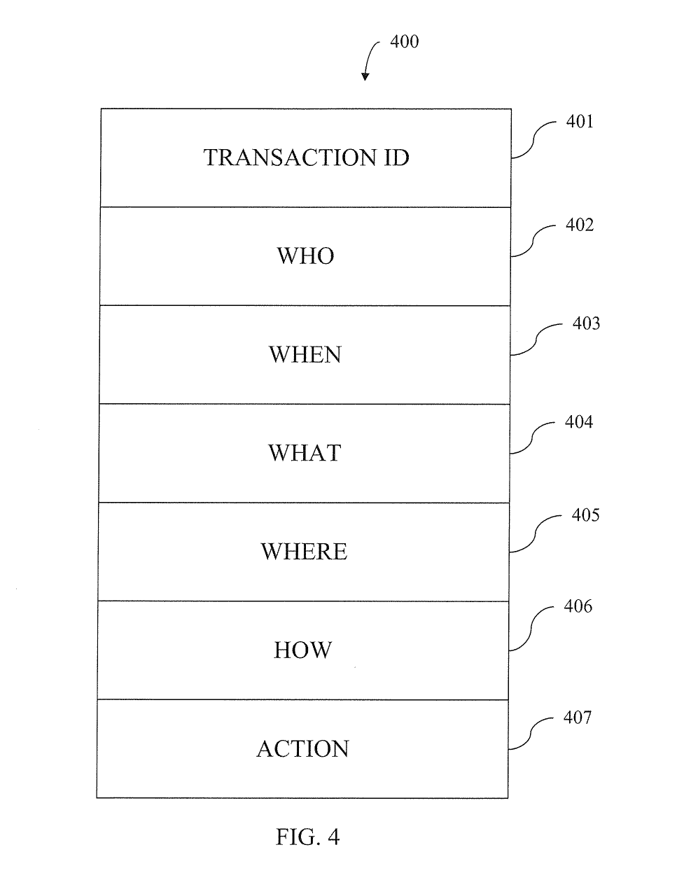

FIG. 4 shows an exemplary GIS data transaction record 400 for each utility asset in a precision database, according to some embodiments of the present invention. As shown, the GIS data transaction record 400 includes a Transaction ID field 401 (record), a WHO field (record) 402, a WHEN field (record) 403, a WHAT field (record) 404, a WHERE field (record) 405, a HOW field (record) 406, and an ACTION field (record) 407. The Transaction ID field 401 includes the identification of the transaction. The WHO field 402 may include user information, information about the data collection device, and the LDS, for example the ID of the device and the ID of a GPS unit.

The WHEN field 403 may include different times associated with the transaction and the collected data, for example manufacture date, installation date, inspection dates, life expectancy, server time, client (device) time, satellite time, and the like. The WHAT field 404 may include areas such as a particular subdivision in a particular county, points such as rocks, valves, topographical points of the areas, and anything else that can be represented by a point. The WHAT field 404 may also include lines, such as cables, pipelines, gas lines, sewage lines, and the like. Additionally, the WHAT field 404 may include meta data related to the points and lines, such as color, manufacturer, size, age, serial numbers, etc. of the valves, cables, pipelines, and others.

The WHERE field 405 may include location data from different coordinates systems, such as satellite coordinate system, x, y, z datums, projection data, and the like. The HOW field 406 may include the type of the LDS, such as the type of the GPS device, laser range finder device, or RFIDs; the type of the data collection device, such as PC, lap top, PDA or specially designed locating tools integrated with GPS (see previous art—data collecting tool); and the like. The ACTION field 407 may include the actions that the operator(s) has taken, for example, add, modify, delete, copy, send, etc.

In some embodiments, a GIS data transaction record may include a combination of some of the records in FIG. 3 and some of the records in FIG. 4. The GIS data transaction record can then be used to generate a precision integrated grid. The precision integrated grid is used to identify and locate a utility in a region, for example, a project area. The information can then be used to warn, for example, a ground-breaking project of the location of above or below ground utilities. Striking or breaking a utility can be of such consequence that tools and methods associated with this task must be of high reliability. Some embodiments generate enhanced utility location data sets that meet usage criteria that are set by project managers responsible for utility asset management and/or damage prevention on a project.

In some embodiments a project manager may set forth and document accuracy, completeness, currency and utility type visibility criteria and requirements for the data sets to be used for the specific project, based on the related GIS data transactions. For example, a project may require a highly specialized set of protocols, rules and compliance standards (SUE engineering) for locating underground utilities. A GIS data transaction record may thus be created that meets the criteria set by the project manager. The completed GIS data transaction may be designated a PI Grid when it meets the project usage criteria set by the project manager.

In some embodiments, some of the data related to the utility assets may be residing on different data sources accessible via a computer network. In some instances, a PI Grid is used by project managers for utility asset management, data distribution and utility damage prevention. Data integrity requirements differ from project to project. The PI Grid may be designed to support a higher level data integrity requirement, for example, damage prevention, pipeline integrity, high consequence area (HCA), emergency planning zone (EPZ), maximum operating pressure (MOP), archeological site each of which require a higher level data integrity requirements and management protocols. By supporting the higher level of data integrity requirement, value added services may be provided for the remainder of utility asset management projects including those that have lesser standards for data integrity.

This way, the method and system of the present invention provides a single source view into a single (conflated) view with the associated precision and pedigree and/or accuracy/precision of each layer and source of each layer to enable a user to determine appropriate protocols based on the quality or precision of the data layers presented including the user's confidence in his or her decision. In some embodiments, the method and system of the present invention determines which data source or layer needs to be improved or updated in order to qualify to meet specific precision and pedigree standards associated with risk levels. For example, data source or layer 1 may be “A” level quality; data source or layer 2 and 3 may be “B” level whereas data source or layer 4 may only qualify as “D” level. If the criteria is no less than “B” level then data source or layer 4 need to be updated or correlated to meet the minimum required standards or precision level.

For example, if data quality is poor, larger buffer zones may be required. If a gas line is being put in the ground and the previous information for that area is old and only qualifies as D quality data, the gas line may have to be exposed and while exposed B quality (more precise) data may be captured using precision GPS data collection devices. Once more precise data is captured, the system of the invention may notify stakeholders (associated entities) of the improved data and various processes/actions may be initiated as a result, for example, decreasing the buffer zone, creating inspection ticket with regulatory agency or the like may be initiated.

As another example, if a gas line is in the vicinity of an area of interest or project area and within a (predetermined) buffer zone based on data pedigree of, for example, C quality, the line may be required to be exposed to capture a better quality location (and other) data to provide increased confidence and to make sure it is not damaged during performance of a project or too much pressure created from cement placed on top of it. For instance, if the gas line is actually 3 ft from where previous records indicated, this could be cause of concern to an electrical company as the data may now indicate that the gas line is too close to an electrical line. In another case, a regulatory agency may need to know about this inaccuracy as it fails the required compliance. Accordingly, both the gas and electrical companies may have to comply with the compliance requirements and thus another agency may have to be notified and get involved to provide proof of proper action to meet compliance. Once the gas line is exposed, a requirement may be to take a GPS reading with a more precise depth, x and y coordinates. Once the new more accurate data is taken and the improved precision and pedigree recorded, all stakeholders may be notified of the new data and also rectify their own internal records (databases) that depend on this new information.

To summarize, the process of data pedigree and data precision and the data conflation begins when the initial dig zone (project area) is identified and may continue through the entire data collection process until all required protocols have been attained and the final records have been captured stored and distributed to the appropriate parties involved, including One Call centers, utility companies, locators and the excavators, until that information is requested once again for the same dig region and the process repeats itself.

It will be recognized by those skilled in the art that various modifications may be made to the illustrated and other embodiments of the invention described above, without departing from the broad inventive step thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A computer implemented method for distribution of utility asset data, the method comprising:
receiving by a computer a selected project area;
searching a database including location data and responsible utility companies for a plurality of utility assets to identify utility assets in the selected project area;
determining an associated utility company for each of the identified utility assets in the selected project area; and
transmitting a notification to the determined utility companies.

2. The method of claim 1, wherein the selected project area is determined by receiving user selection identifying an area on a map.

3. The method of claim 1, wherein the selected project area is determined by one or more of specifying an address, specifying an intersection, specifying a land mark, and specifying a postal zip code.

4. The method of claim 1, wherein the notification includes buffer zones for some of the utility assets in the selected project area.

5. The method of claim 4, wherein the buffer zones are based on a confidence level that a utility company has in location data of a respective utility asset and the type of the respective utility asset.

6. The method of claim 1, wherein the utility assets in the selected project area are identified from the database based on the location data and project type.

7. The method of claim 1, wherein the utility assets in the selected project area are identified from the database based on the location data and utility asset type.

8. The method of claim 1, further comprising transmitting the notification to a mobile device.

9. The method of claim 1, wherein the database further includes contact information and type of notification to be sent for each of the responsible utility companies.

10. The method of claim 1, wherein the database further includes a protocol record including one or more of a safety measure to be put forth to protect a respective utility asset from being damaged, certification process, repair process, replacement process, and regulations governing the type of the respective utility asset or the responsible utility company for the respective utility asset.

11. The method of claim 1, wherein the database comprises a plurality of different data source accessible via a computer network.

12. The method of claim 11, wherein the database further includes a risk level record for at least some of the utility assets including one or more of a risk level for each of the at least some of the utility assets depending on the types of the utility assets, the location of the utility assets, and a precision and pedigree of the data sources for the utility assets.

13. The method of claim 12, wherein the risk level depends on a project type.

14. The method of claim 12, further comprising determining which data source needs to be improved or updated to qualify to meet specific precision and pedigree standards associated with the risk level required for a project type or a utility asset type.

15. A system for distribution of utility asset data comprising:
an input device for receiving a selected project area;
a database for storing location data and responsible utility companies for a plurality of utility assets to identify utility assets in the selected project area;
a processor for determining an associated utility company for each of the utility assets in the selected project area; and
a transmitter for transmitting a notification to the determined utility companies.

16. The system of claim 15, wherein the database further includes contact information and type of notification to be sent for each of the responsible utility companies.

17. The system of claim 15, wherein the database further includes a protocol record including one or more of a safety measure to be put forth to protect a respective utility asset from being damaged, certification process, repair process, replacement process, and regulations governing the type of the respective utility asset or the responsible utility company for the respective utility asset.

18. The system of claim 15, wherein the database comprises a plurality of different data source residing on one or more computers and accessible via a computer network.

19. The system of claim 18, wherein the database further includes a risk level record for at least some of the utility assets including one or more of a risk level for each of the at least some of the utility assets depending on the types of the utility assets, the location of the utility assets, and a precision and pedigree of the data sources for the utility assets.

20. The system of claim 18, the processor is configured to determine which data source needs to be improved or updated to qualify to meet specific precision and pedigree standards associated with the risk level required for a project type or a utility asset type.
